(19) United States
(12) Patent Application Publication
(10) Pub. No.: US 2020/0220178 A1
(43) Pub. Date: Jul. 9, 2020

(54) NEGATIVE ELECTRODES FOR USE IN ACCUMULATORS OPERATING ACCORDING TO THE ION INSERTION AND DEINSERTION OR ALLOY FORMATION PRINCIPLE AND ACCUMULATOR COMPRISING SUCH AN ELECTRODE

(71) Applicant: COMMISSARIAT À L'ÉNERGIE ATOMIQUE ET AUX ÉNERGIES ALTERNATIVES, Paris (FR)

(72) Inventors: Elise Gutel, Grenoble (FR); Lionel Blanc, Grenoble (FR); Willy Porcher, Grenoble (FR); Yvan Reynier, Grenoble (FR)

(21) Appl. No.: 16/735,081

(22) Filed: Jan. 6, 2020

(30) Foreign Application Priority Data
Jan. 8, 2019 (FR) 1900167

(51) Int. Cl. H01M 4/66; H01M 2/16

(52) U.S. Cl. CPC H01M 4/667; H01M 4/662; H01M 2004/028; H01M 4/663; H01M 2/1673

(57) ABSTRACT

A negative electrode for an accumulator functioning based on the ion insertion and deinsertion principle and/or based on the alloy formation and dealloying principle, the negative electrode comprising: a first layer comprising an active material deposited via one of its faces, on a first face of a current collector; a second layer comprising an active material deposited via one of its faces, on a second face of a current collector, the first face being opposite the second face; wherein the current collector is provided with through holes connecting the first layer to the second layer and in that the first layer is coated with a layer composed of a metal, the corresponding cations of which are those used in the ion insertion and deinsertion process and/or in the alloy formation and dealloying process in the active material of the first layer and the second layer.

### CROSS-REFERENCE TO RELATED APPLICATIONS

This application claims priority from French Patent Application No. 19 00167 filed on Jan. 8, 2019. The content of this application is incorporated herein by reference in its entirety.

### TECHNICAL FIELD

This invention relates to a new type of negative electrode intended for use in:
accumulators functioning according to the principle of ion insertion and deinsertion in the active material of the electrode (also called the ion intercalation or deintercalation principle), accumulators of this type possibly being M¹-ion accumulators, where M¹ corresponds to an alkali element (such as Li, Na, K) or M²-ion accumulators, where M² corresponds to an alkali earth element (such as Ca, Mg); or
accumulators functioning according to the alloy formation or dealloying principle with at least one of the active electrode materials.

Accumulators of this type are intended for use as an autonomous energy source, particularly in portable electronic equipment (such as mobile telephones, laptop computers, tooling), in order to progressively replace nickel-cadmium (NiCd) and nickel-metal hydride accumulators (NiMH). They can also be used to provide the energy supply necessary for new microapplications such as smart cards, sensors or other electromechanical systems and for electromobility.

From the functional point of view, the above-mentioned accumulators function either according to the principle of ion insertion-deinsertion in active materials, or according to the principle of alloy formation or dealloying with at least one of the active materials, such as lithium that can form an alloy with tin.

As an example, considering lithium accumulators, as the accumulator discharges, the negative electrode releases lithium in ion form Li⁺, that migrates through the ion conducting electrolyte and is incorporated in the active material of the positive electrode to form an insertion material or an alloy. The passage of each Li⁺ ion in the internal circuit of the accumulator is exactly compensated by the passage of an electron in the external circuit thus generating an electric current.

On the other hand, reactions that take place within the accumulator when the accumulator is being charged, are inverse to those that take place during discharge, namely:
the negative electrode will incorporate lithium in the lattice of the material from which it is composed, to form an insertion material or an alloy; and
the positive electrode will release lithium, which will be incorporated into the material of the negative electrode to form an insertion material or an alloy.

During the first charge cycle of the accumulator, when the active material of the negative electrode is brought to a lithium insertion potential or the lithium alloy formation potential, some of the lithium will react with the electrolyte on the surface of the grains of active material of the negative electrode to form a passivation layer on its surface. Formation of this passivation layer consumes a non-negligible quantity of lithium ions that is materialised by an irreversible loss of capacity of the accumulator (this loss being qualified as irreversible capacity and that can be evaluated at the order of 5 to 20% of the total initial capacity of the system), due to the fact that lithium ions that have reacted are no longer available for subsequent charge/discharge cycles. Other surface reactions can also take place with consumption of lithium, such as reduction of the oxide layer at the surface of the active material, particularly when it is silicon, to form Li₄SiO₄ type compounds. Furthermore, some of the insertion reactions in the insertion materials can be irreversible, which consumes lithium that will no longer be available afterwards.

Therefore these losses must be minimised during the first charge or at least they should be compensated so that the energy density of the accumulator is as high as possible.

To compensate this phenomenon, a supplementary lithium source in the negative electrode material could be envisaged, which can also act as an ion reserve to compensate for losses during the life of the accumulator and thus to extend it.

To achieve this, techniques for introducing additional lithium into the negative electrode have been disclosed to mitigate the above-mentioned disadvantage, among which mention may be made of “in situ” prelithiation techniques and “ex situ” prelithiation techniques.

Concerning techniques called “in situ”, they consist of introducing metallic lithium (in other words with “0” degree of oxidation) into the negative electrode for example in the form of a metallic lithium powder stabilised by a protective layer (as described in Electrochemistry Communications 13 (2011) 664-667) mixed with ink containing the ingredients of the negative electrode (namely, the active material, the electron conductors and an organic binder), the lithium being inserted spontaneously by a corrosion phenomenon, the advantage of this technique being that it can be directly integrated in the electrode manufacturing process, however with the disadvantages that it cannot enable the use of aqueous pathways for manufacturing the electrodes, due to the use of metallic lithium and that it allows residual porosity to subsist in the electrode once the lithium has been consumed.

Concerning “ex situ” techniques, they consist of electrochemically prelithiating the negative electrode, for example galvanostatically, by placing it in an assembly comprising an electrolytic bath and a counterelectrode comprising lithium, these techniques being used to check the quantity of lithium introduced into the negative electrode, but however also having the disadvantage of requiring that a major experimental set up is implemented. In particular, since the electrode is very reactive to air and to humidity, all assembly steps of the accumulator must be made under a perfectly inert atmosphere.

With regard to prior art, there is a genuine need for negative electrodes for a metallic insertion-deinsertion accumulator or accumulator with alloy formation with a sufficiently high metallisation content throughout the entire volume of the electrodes, so as to mitigate irreversible capacity losses and also, having a sufficiently large surface area so that they can be used, particularly, in accumulators with a spiral architecture.

The authors of this invention have set themselves the objective of satisfying this need by the use of negative electrodes characterised by a specific design.

### PRESENTATION OF THE INVENTION

Thus, the invention relates to a negative electrode for an accumulator functioning based on the ion insertion and deinsertion principle and/or based on the alloy formation and dealloying principle, said negative electrode comprising:
a first layer comprising an active material deposited via one of its faces, on a first face of a current collector;
a second layer comprising an active material deposited via one of its faces, on a second face of a current collector, said first face being opposite said second face;
characterised in that the current collector is provided with through holes connecting the first layer to the second layer and in that the first layer is coated with a layer composed of a metal, the corresponding cations of which are those used in the ion insertion and deinsertion process and/or in the alloy formation and dealloying process in the active material of the first layer and the second layer.

In the above and in the following description, negative electrode classically means the electrode that acts as the anode when the generator outputs current (in other words when it is in the discharge process) and that acts as the cathode when the generator is in the charge process.

In the above and in the following description, active material classically means, when the accumulator functions according to the ion insertion and deinsertion principle, the material that is directly involved in reversible ion insertion and deinsertion reactions in electrode active materials during charging and discharging processes, in the sense that it can insert and deinsert ions in its lattice (more specifically, cations in this case corresponding to the metal making up the layer composed of a metal, these ions can be alkali ions, particularly lithium ions, when the accumulator is a lithium-ion accumulator, sodium ions when the accumulator is a sodium-ion accumulator, potassium ions when the accumulator is a potassium-ion accumulator, or alkali earth ions such as magnesium ions when the accumulator is a magnesium-ion accumulator, or calcium ions when the accumulator is a calcium-ion accumulator).

In the above and in the following description, active material classically means, when the accumulator functions according to the alloy formation and dealloying principle, a material that is involved in alloy formation or dealloying reactions during charge and discharge processes.

In the above and in the following description, metal means the metallic element at its 0 degree oxidation.

By disclosing such an electrode design, the authors of this invention have thus provided a solution to problems of irreversible loss of capacity of electrodes, for example large surface area electrodes, particularly with a spiral accumulator architecture, by allowing diffusion of cations originating from the layer composed of a metal throughout the entire volume of the electrode. Once the electrodes according to the invention have been brought into contact with an electrolyte (namely, once they have been installed in an accumulator or after being brought into contact with an electrolyte before assembly of the negative electrode in an accumulator), the layer composed of a metal will be subjected to a corrosion phenomenon, from which cations are derived (said cations corresponding to cations involved in the insertion-deinsertion process or alloy formation or dealloying process of the accumulators in which they will be incorporated) that will be able to diffuse from the first layer to the second layer via through holes provided in the current collector.

The electrodes are thus in the form of bilayer electrodes, the two layers being located on each side of a current collector provided with through holes connecting the two layers, each of the two layer comprising an active material and one of the layers (in fact the first layer) being coated on one of its faces with a layer composed of a metal, the corresponding cations of which are cations involved in the ion insertion or deinsertion process and/or in the alloy formation and dealloying process in the active material of the first layer and the second layer.

The negative electrodes according to the invention can extend in length along a longitudinal direction of the electrode and more specifically adopt a band shape, as is also the case for the first layer, the second layer and the layer composed of a metal.

The active material in the first layer is conventionally identical to the active material in the second layer.

Furthermore, the active material in the first layer and the active material in the second layer is advantageously not composed of the metal used in the composition of the layer composed of deposited metal.

The active material, either for the first layer and/or the second layer, may in particular be a material that can intercalate or deintercalate ions that are those originating from the metal forming the layer composed of a metal and that are responsible for functioning of the accumulator when it functions according to the ion insertion and deinsertion principle. The active material may also be a material capable of reversibly forming an alloy with the metal in the layer composed of the metal when the accumulator functions according to the alloy formation and dealloying principle.

More specifically, the active material, either for the first layer and/or the second layer, may in particular be:
a material that can insert or deinsert alkali ions when the accumulator is an M¹-ion accumulator, in which M¹ represents an alkali ion (such as lithium ions when the accumulator is a lithium-ion accumulator; sodium ions when the accumulator is a sodium-ion accumulator; potassium ions when the accumulator is a potassium-ion accumulator, and the layer composed of a metal is a layer composed of an alkali metal;
a material that can insert or deinsert alkali earth ions when the accumulator is an M²-ion accumulator, in which M² represents an alkali earth ion (such as magnesium ions when the accumulator is a magnesium-ion accumulator; calcium ions when the accumulator is a calcium-ion accumulator) and the layer composed of a metal is a layer composed of an alkali earth metal.

In particular, the active material, either for the first layer and/or the second layer, can be chosen from among:
silicon;
a carbon material such as hard carbon, natural graphite or artificial graphite; and
mixtures thereof;
these active materials being adapted for the M¹-ion or M²-ion accumulators mentioned above.

As an example of an active material, mention may be made in particular of a silicon-graphite composite material that is composed, for example of an aggregate of graphite particles and silicon particles.

When the accumulator functions based on the alloy formation and dealloying principle, the active material for either the first layer and/or the second layer may be a material capable of forming an alloy with the metal in the layer composed of metal, this material possible being tin, for example.

Furthermore, in addition to an active material, the first layer and the second layer may comprise at least one organic binder and at least one electron conducting material containing carbon.

The organic binder(s) can be chosen from among vinyl polymers such as polyvinylidene fluorides (PVDF), modified celluloses such as carboxymethylcelluloses (CMC) possibly in the form of salts (for example sodium carboxymethylcelluloses, ammonium carboxymethylcelluloses), styrene-butadiene copolymer latexes (SBR), polyacrylates such as lithium polyacrylates, polyamides, polyimides, polyesters and mixtures thereof.

The electron conducting carbon material may be a material comprising carbon in the elementary state and preferably in divided form, such as spherical particles, chips or fibres.

As a carbon material, mention may be made of graphite, mesocarbon balls; carbon fibres; carbon black such as acetylene black, channel black, furnace black, lamp black, anthracene black, charcoal black, gas black, thermal black; graphene; carbon nanotubes; and mixtures thereof.

The active material may be present in the first layer or the second layer, in a content varying from 50 to 99% by mass relative to the total mass of ingredients of the first layer or the second layer.

The organic binder(s) may be present in a content varying from 1 to 30% by mass relative to the total mass of ingredients in the first or the second layer.

Finally, the electron conducting carbon material may be present in a content varying from 1 to 20% by mass relative to the total mass of ingredients in the first layer or the second layer.

Each of the layers comprising an active material (namely the first layer and the second layer mentioned above) can be between 10 μm and 200 μm thick and may also be between 0.001 m and 1 m wide and between 0.01 m and 100 m long.

As mentioned above, one of the faces of the first layer is coated with a layer composed of a metal, the corresponding cations of which are those used in ion insertion and deinsertion process and/or in the alloy formation and dealloying process in the active material of the first layer.

It is understood that the face of the first layer on which the layer composed of a metal is deposited, is not the face that acts as the deposition face on the current collector. In other words, the first layer can be defined as a first layer comprising an active material deposited, via a first face, on a first face of a current collector and being coated on a second face by a layer composed of a metal, of which the corresponding cations are those involved in the ion insertion or deinsertion process and/or in the alloy formation and dealloying process in the active material of the first layer and the second layer, said first face of the first layer and said second face of the first layer being opposite to each other.

The layer composed of a metal may in particular be:
a layer composed of an alkali metal, in particular, when the accumulator in which the negative electrode will be incorporated is an M¹-ion accumulator, in which M¹ represents an alkali ion (such as lithium ions when the accumulator is a lithium-ion accumulator in which case the layer is composed of metallic lithium; sodium ions when the accumulator is a sodium-ion accumulator in which case the layer is composed of metallic sodium; potassium ions when the accumulator is a potassium-ion accumulator in which case the layer is composed of metallic potassium);
a layer composed of a alkali earth metal, in particular, when the accumulator in which the negative electrode will be incorporated is an M²-ion accumulator, in which M² represents an alkali earth ion (such as magnesium ions when the accumulator is a magnesium-ion accumulator in which case the layer is composed of metallic magnesium; calcium ions when the accumulator is a calcium-ion accumulator in which case the layer is composed of metallic calcium).

This layer composed of a metal may be in the form of a metal foil with a thickness varying from 1 μm to 100 μm, for example a thickness greater than or equal to 20 μm, for example equal to 50 μm and may also have a width varying from 0.001 m to 1 m and a length varying from 0.01 m to 100 m.

Placing such a layer on only one of the layers comprising an active material can avoid the use of an excessively thin metal foil (for example foil less than 50 μm thick) that is difficult to manipulate during manufacturing of the negative electrode and, on the other hand, make it possible to use a metal foil with double thickness (for example with a thickness of more than 20 μm) due to the fact that the overthickness conferred on the negative electrode by the presence of this metallic layer is only applied on one of the layers comprising an active material.

The current collector placed between the first layer and the second layer is a current collector in which there are through holes connecting the first layer to the second layer.

In particular, it may be a collector in which there are perforations, which may preexist before the placement of layers on the active material. In particular, it can be a grillage type collector that can be commercially available and that can have been manufactured before the deposition of electrode layers (for example using a technique involving the use of a laser) or then after deposition of electrode layers, in which case these are also perforated.

The current collector may be in the form of a grillage or a plate with holes with a thickness varying from 5 μm to 100 μm, for example 10 μm and that, when it is rectangular in shape, can have a length varying from 0.01 m to 100 m and a width varying from 0.001 m to 1 m.

The current collector can have an open surface varying from 1 to 90% of the total surface area of the collector.

Finally, from a composition point of view, the current collector may comprise (or even be composed of) one or several metals chosen from among copper, aluminium, nickel and alloys thereof. It may possibly comprise carbon fibres.

[FIG. 1] attached in the appendix is an exploded view illustrating a specific negative electrode conforming with the invention, comprising a stack comprising a succession of the following elements: the layer composed of a metal 1, the first layer 3 comprising an active material, the grillage type current collector 5, the second layer 7 comprising an active material, the through holes 6 of the current collector passing from the first layer to the second layer.

The first layer may also be provided with through holes, advantageously located along the prolongation of the holes in the current collector which in other words means that the through holes in the first layer and those in the current collector connect the layer composed of metal and the second layer.

The second layer may also advantageously be provided with through holes located along the prolongation of the holes in the current collector.

According to one particular embodiment of the invention, the first layer is provided with through holes located along the prolongation of the holes in the current collector and the second layer is also provided with through holes located along the prolongation of the holes in the current collector, which in other words means that the through holes pass through the assembly from the second layer to the first layer.

[FIG. 2] appended in the appendix illustrates a negative electrode satisfying this particular mode of the invention, of which the two opposite faces are shown, comprising the layer composed of metal 9, the first layer 11 comprising an active material and in which there are through holes 13, the current collector 15, the second layer 17 comprising an active material and in which there are also through holes 18.

The negative electrode may be prepared using different processes.

According to a first variant, the negative electrodes can be prepared using a process including the following steps:
a) a step to deposit on a first face of a current collector in which there are through holes, a first layer comprising an active material and a second layer comprising an active material on a second face of the current collector, said first face and said second face being opposite each other;
b) a step to deposit a layer composed of a metal on the first layer comprising the active material, the corresponding cations of the layer composed of a metal are those involved in the ion insertion or deinsertion process in the active material of the first layer and the second layer or in the alloy formation and dealloying process in the active material of the first layer and the second layer.

The deposition step a) thus comprises two phases: an operation to deposit the first layer on a first face of the current collector, the first layer comprising an active material and an operation to deposit the second layer on a second face of the current collector, the second layer comprising an active material.

More specifically, each deposition operation may consist of depositing a liquid composition, and more specifically a shear thinning composition (that can be qualified as an ink) comprising ingredients making up the layers concerned (in particular the active material, possibly an organic binder and possibly an electron conducting carbon material), the liquid composition, more specifically a shear thinning composition, advantageously being identical for the first layer and the second layer, when the first layer and the second layer are identical.

These deposition operations can be made using conventional deposition techniques such as spraying, dip coating, coating.

The layer thus deposited can be dried after each deposition operation.

The step b) to deposit a layer composed of a metal on the first layer comprising the active material may consist of bringing for example a foil composed of said metal into contact with the first layer, and carrying out a co-rolling to assure good bond between the layer composed of a metal and the first layer. To achieve this, the assembly formed from the first layer and the second layer located on each side of the current collector and the layer composed of a metal may be passed into a device comprising two rollers to obtain sufficient bond.

According to a second variant, the negative electrodes can be prepared using a method including the following steps:
c) a step to deposit a first layer comprising an active material on a first face of an unperforated current collector and a second layer comprising an active material on a second face of the current collector, said first face and said second face being opposite each other;
d) a step to apply a perforator on the assembly obtained in step a), to form the collector provided with through holes;
e) a step to deposit a layer composed of a metal on the first layer comprising the active material, the corresponding cations of the layer composed of a metal are those involved in the ion insertion and deinsertion process in the active material of the first layer and the second layer or in the alloy formation and dealloying process in the active material of the first layer and the second layer.

The methods described for step a) above are equally valid for step c) mentioned above, except that in step c), the current collector is an unperforated current collector.

Step d) may be done using a perforator such as a device comprising a spiked roller and more specifically a microspiked roller, this roller being displaced on the surface of the first layer while applying pressure on the roller, such that the spikes on the roller pass through the assembly composed of the two layers and the unperforated current collector to generate through holes from the first layer to the second layer.

The methods described for step b) above are also valid for step e) mentioned above, except that the presence of through holes on the first layer can also improve the bond of the layer composed of metal.

The method defined in this second variant is adapted to the preparation of negative electrodes conforming with the invention, the through holes of which pass from the first layer to the second layer, passing through the current collector.

The negative electrodes according to the invention can be introduced as such into an accumulator or can be introduced into it in an activated form, in other words in a form in which the metal present in the layer has been corroded and the ions formed during this diffusion have diffused both into the thickness of the first layer and into the thickness of the second layer, this diffusion into the thickness of the second layer being made possible by the presence of the collector comprising the through holes.

Thus, the invention relates to a method for activation of a negative electrode as defined above comprising a step to bring the negative electrode into contact with an electrolyte for a fixed duration and at a fixed temperature to cause corrosion of the metal in the layer composed of a metal into metal cations (for example, Li⁺ cations when the layer is composed of lithium, Na⁺ cations when the layer is composed of sodium, K⁺ cations when the layer is composed of potassium).

According to a first variant, this step to bring the negative electrode into contact with an electrolyte may be done by placing said electrode in a bag comprising the electrolytic composition, this bag possibly being a flexible or rigid hermetically sealed bag (for example a heat-sealed bag) and then by placing the bag comprising the electrolytic composition in a drying oven. Concomitantly to this step, it may be applied a pressure on the negative electrode to generate a mechanical stress that will enable better diffusion of metallic ions originating from corrosion of a layer composed of the metal.

In particular, the electrolyte may be a liquid electrolyte comprising a metal salt dissolved in at least one organic solvent such as an apolar aprotic solvent, the metal salt more specifically comprising a metal cation with exactly the same nature as the metal cations originating from corrosion of the layer composed of a metal.

The metal salt may in particular be a lithium salt when the layer composed of a metal is a lithium layer.

As examples of lithium salts, mention may be made of LiClO₄, LiAsF₆, LiPF₆, LiBF₄, LiRfSO₃, LiCH₃SO₃, LiN(RfSO₂)₂, Rf being chosen from among F or a perfluoroalkyl group containing 1 to 8 carbon atoms, lithium trifluoromethanesulfonylimidide (known under the abbreviation LiTFSI), lithium bis(oxalato)borate (known under the abbreviation LiBOB), lithium bis(perfluorethylsulfonyl)imidide also known under the abbreviation LiBETI), lithium fluoroalkylphosphate (known under the abbreviation LiFAP).

As examples of organic solvents that can be used in the composition of the electrolyte, mention may be made of carbonate solvents, such as cyclic carbonate solvents, linear carbonate solvents and mixtures thereof.

As examples of cyclic carbonate solvents, mention may be made of ethylene carbonate (symbolised by the abbreviation EC), propylene carbonate (symbolised by the abbreviation PC).

As examples of linear carbonate solvents, mention may be made of diethyl carbonate (symbolised by the abbreviation DEC), dimethyl carbonate (symbolised by the abbreviation DMC), ethylmethyl carbonate (symbolised by the abbreviation EMC).

According to a second variant, the step to bring the negative electrode into contact with an electrolyte may be done using the following operations:
an operation to place the negative electrode in an accumulator type device;
an operation to bring the accumulator into contact with an electrolyte for a fixed duration and at a fixed temperature to cause corrosion of the metal in the layer composed of a metal into metal cations (for example, Li⁺ cations when the layer is composed of lithium, Na⁺ cations when the layer is composed of sodium, K⁺ cations when the layer is composed of potassium).

The operation to place the negative electrode in an accumulator type device can consist of preparing an accumulator, in which the negative electrode according to the invention is shared between a first cell and a second cell, said first cell containing a positive electrode, an electrolytic separator and the first layer comprising an active material coated with the layer composed of a metal, said electrolytic separator being arranged sandwiched between the positive electrode and the layer composed of metal and the second cell comprising a positive electrode, an electrolytic separator and the second layer comprising an active material, said electrolytic separator being arranged sandwiched between the positive electrode and the second layer comprising an active material.

This accumulator preparation may be made by stacking a first electrolytic separator on the layer composed of a metal and a positive electrode on the first electrolytic separator and then a second electrolytic separator on the second layer comprising an active material and a positive electrode on the second electrolytic separator, the resulting accumulator being shown on FIG. 3 attached in the appendix comprising:
the negative electrode 20 comprising a first layer 21 comprising an active material coated with a layer composed of a metal 23 and a second layer 25 comprising an active material and a current collector 27 in which there are through holes;
a first electrolytic separator 29 deposited on the layer composed of a metal;
a positive electrode 31 deposited on the first electrolytic separator 29;
a second electrolytic separator 33 deposited on the second layer 25; and
a positive electrode 35 deposited on the second electrolytic separator 33;
each positive electrode being associated with a current collector 37, for example such as an aluminium metal foil.

The accumulator mentioned above is a flat accumulator. An accumulator with the same elements as those mentioned above could also be envisaged, these various elements then being wound to form a cylindrical wound accumulator.

The step to bring the negative electrode into contact with an electrolyte can take place in a manner similar to that described for the case in which said step takes place directly with a negative electrode not placed in an accumulator.

After the process mentioned above, either for the first variant or the second variant, the layer composed of a metal is a corroded layer, of which all or some of the metal has been transformed into metal ions that diffused in the first layer and in the second layer via the current collector in which through holes are formed.

Finally, the invention relates to an accumulator functioning based on the principle of ion insertion-deinsertion or the alloy formation and dealloying process comprising a negative electrode as defined above or a negative electrode obtained after the activation process defined above, which includes a corroded layer instead of the layer composed of a metal, of which all or some of the metal has been transformed into metal ions that diffused in the first layer and in the second layer via the current collector with through holes.

More specifically, the accumulator comprises a first cell and a second cell separated from each other by the current collector of the negative electrode, said first cell containing a positive electrode, a first electrolytic separator and the first layer comprising an active material coated with the layer composed of a metal of the negative electrode, the first electrolytic separator being arranged sandwiched between the positive electrode and the layer composed of metal and said second cell comprising a positive electrode, an electrolytic separator and the second layer comprising an active material of the negative electrode, said electrolytic separator being arranged sandwiched between the positive electrode and the second layer comprising an active material.

As a variant, when the negative electrode used in the accumulator is the electrode obtained after the activation process, the accumulator may include a first cell and a second cell separated from each other by the negative electrode current collector, said first cell containing a positive electrode, a first electrolytic separator and the first layer comprising an active material coated with the layer composed of a metal of the negative electrode, said first electrolytic separator being arranged sandwiched between the positive electrode and the layer composed of metal and said second cell comprising a positive electrode, a second electrolytic separator and the second layer comprising an active material of the negative electrode, said second electrolytic separator being arranged sandwiched between the positive electrode and the second layer comprising an active material.

In the above and in the following description, positive electrode classically means the electrode that acts as the cathode when the generator outputs current (in other words when it is in the discharge process) and that acts as the anode when the generator is in the charge process.

The positive electrode classically comprises an active material in other words a material that can participate in insertion and deinsertion reactions that occur when the accumulator is functioning (when it is functioning according to the ion insertion and deinsertion principle) or in alloy formation and dealloying reactions (when the accumulator is an accumulator functioning according to the alloy formation and dealloying principle).

When the accumulator is an M¹-ion type accumulator (M¹ being an alkali ion such as Li, Na, K), the active material of the electrode can be a material of the M¹ oxide type comprising at least one metallic transition and/or post-transition element, of the M¹ phosphate type comprising at least one metallic transition element, of the M¹ silicate type comprising at least one metallic transition element or of the M¹ borate type comprising at least one metallic transition element.

Among examples of M¹ oxide compounds comprising at least one metallic transition and/or post-transition element, mention may be made of simple oxides or mixed oxides (in other words oxides containing several distinct metallic transition and/or post-transition elements) comprising at least one metallic transition and/or post-transition element, such as oxides containing nickel, cobalt, manganese and/or aluminium (these oxides possibly being mixed oxides).

More specifically, among mixed oxides containing nickel, cobalt, manganese and/or aluminium, mention can be made of the compounds with the following formula:

M¹M′O₂

wherein M′ is an element chosen from among Ni, Co, Mn, Al and mixtures thereof and M¹ is an alkali element.

Among examples of such oxides, mention may be made of lithiated oxides LiCoO₂, LiNiO₂ and mixed oxides Li(Ni,Co,Mn)O₂ (such as Li(Ni_{1/3}Mn_{1/3}Co_{1/3})O₂ or Li(Ni_{0.6}Mn_{0.2}Co_{0.2})O₂ (also known under the name NMC), Li(Ni,Co,Al)O₂ (such as Li(Ni_{0.8}Co_{0.15}Al_{0.05})O₂ also known under the name NCA) or Li(Ni,Co,Mn,Al)O₂, oxides said to be lithium-rich oxides Li₁₊ₓ(Ni,Co,Mn)O₂, in which x is greater than 0.

Among examples of such oxides, mention may be made of sodium oxides NaCoO₂, NaNiO₂ and mixed oxides Na(Ni,Co,Mn)O₂ (such as Na(Ni_{1/3}Mn_{1/3}Co_{1/3})O₂), Na(Ni,Co,Al)O₂ (such as Na(Ni_{0.8}Co_{0.15}Al_{0.05})O₂) or Na(Ni,Co,Mn,Al)O₂.

Among examples of M¹ phosphate compounds containing at least one metallic transition element, mention may be made of compounds with formula M¹M″PO₄, wherein M″ is chosen from among Fe, Mn, Ni, Co and mixtures thereof and M¹ is alkali, such as LiFePO₄.

Among examples of M¹ silicate compounds containing at least one metallic transition element, mention may be made of compounds with formula M¹₂M″′SiO₄, wherein M″′ is chosen from among Fe, Mn, Ni, Co and mixtures thereof and M¹ is an alkali element.

Among examples of lithiated borate compounds containing at least one metallic transition element, mention may be made of compounds with formula M¹M″′BO₃, wherein M″′ is chosen from among Fe, Mn, Co and mixtures thereof and M¹ is an alkali element.

When the accumulator is an M²-ion type accumulator (in which M² is an alkali earth ion), the active material of the electrode can be MoS₆.

Furthermore, the positive electrode may also include at least one organic binder such as a polymeric binder, such as polyvinylidene fluoride (PVDF), a mixture of carboxymethylcellulose with a styrene and/or acrylic latex and at least one electricity conducting additive, that can be a carbon material such as carbon black. Furthermore the positive electrode can structurally be a composite material comprising a matrix of organic binders within which fillers are dispersed composed of the active material (for example in particulate form) and possibly the electricity conductive additive(s).

The electrolytic separator is classically a porous polymeric membrane impregnated with an electrolyte, such as a liquid electrolyte as defined above.

The accumulators according to the invention can have a plane architecture or a wound or spiral architecture.

Other characteristics and advantages of the invention will become clear after reading the following additional description and that applies to particular embodiments.

Obviously, this additional description is only given to illustrate the invention and in no way forms a limitation of it.

### BRIEF DESCRIPTION OF THE DRAWINGS

FIG. 1, already commented upon, illustrates a specific negative electrode conforming with the invention and shown in an exploded view.

FIG. 2, already commented upon, illustrates a negative electrode conforming with a particular embodiment of the invention.

FIG. 3, already commented upon, illustrates an accumulator conforming with the invention.

FIG. 4 is a graph representing the variation of the discharged capacity C (in mAh) as a function of the number N of cycles, curve a) illustrating the curve for an accumulator conforming with the invention and curve b) illustrating the curve for an accumulator not conforming with the invention.

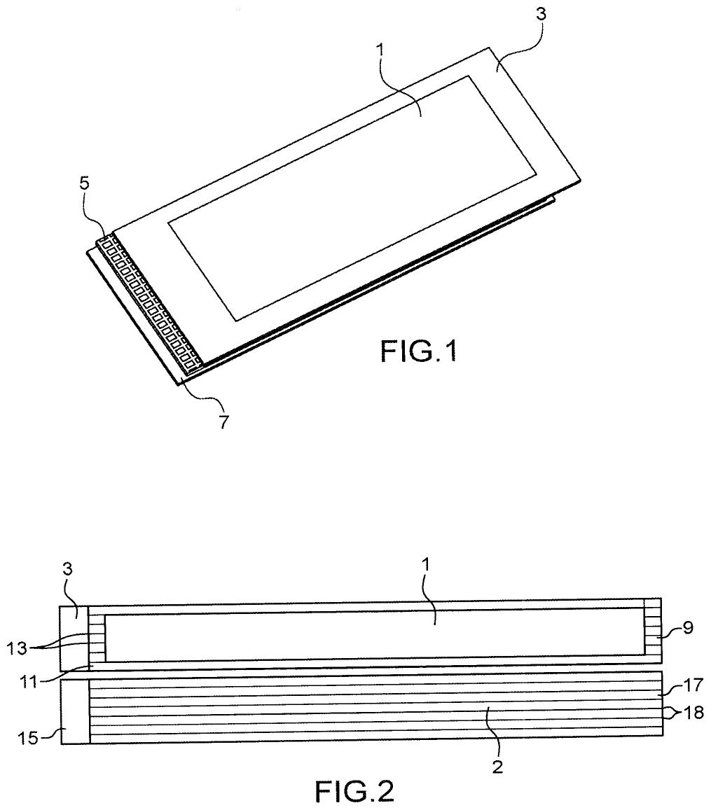

### DETAILED PRESENTATION OF PARTICULAR EMBODIMENTS

### Example

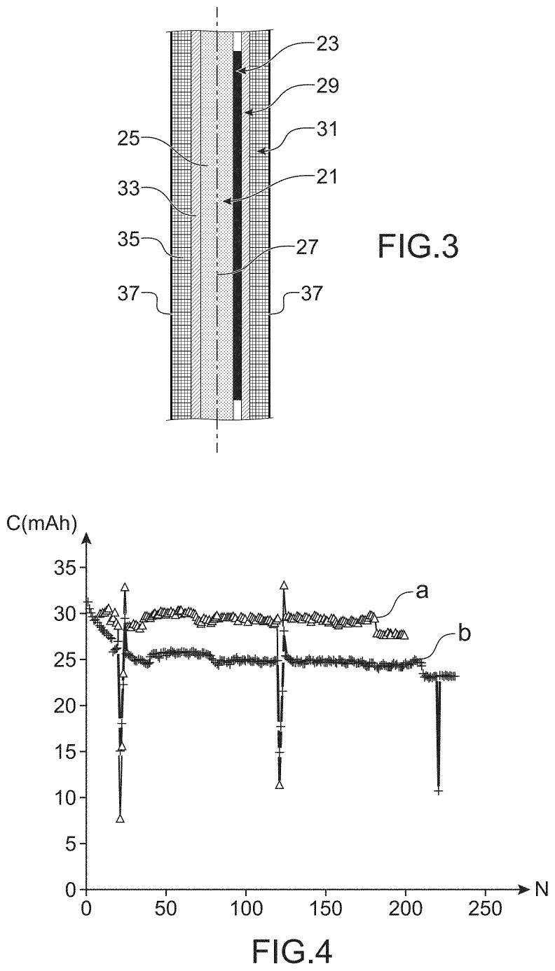

This example illustrates an accumulator conforming with the invention as represented in section on [FIG. 3] already defined above, this accumulator more specifically satisfying the following specific features:
the positive electrodes are composed of a composite material comprising an NMC type active material (92% by mass), 4% by mass of a Super P carbon black electron conducting additive and 4% by mass of a polyvinylidene fluoride (PVDF) type binder, the positive electrodes being 65 μm thick and being associated with an aluminium foil type current collector with a thickness of 20 μm and a surface area of 10.2 cm²;
the separators are 20 μm thick Celgard® type polymeric separators with a porosity of 40%, these separators also having a square shape with a side dimension of 40 mm;
for the negative electrode, the first layer and the second layer are composed of a composite material comprising an active material consisting of a graphite silicon composite (92% by mass), 2% by mass of a Super P carbon black electron conducting additive and 6% by mass of an acrylic polymer type binder;
the layer composed of a metal is a lithium foil with dimensions 27 mm*27 mm and a thickness of 50 μm;
the current collector is copper foil with a thickness of 10 μm;
the negative electrode being provided with through holes from the first layer to the second layer and passing through the current collector, the holes having a diameter of 0.25 mm and being distributed at a density of 60 holes/cm², the assembly formed from the two layers, the lithium foil and the current collector being 100 μm thick with a surface area of 12.25 cm².

In parallel, in this example an accumulator not conforming with the invention is set up satisfying the same specificities as those mentioned above for the accumulator conforming with the invention, except that there are no through holes in the negative electrode and its current collector is an unperforated collector (in other words it does not have any through holes).

Each of the accumulators is placed in a flexible bag filled with an electrolyte comprising LiPF₆ (1 M) and a mixture of ethylmethyl carbonate (EMC) and fluoroethylene carbonate (in the proportion 70/30) and 2% by mass of vinylene carbonate (VC). Each bag is heat sealed allowing a positive connector and a negative connector to project, electrically connected to the electrodes by ultrasound soldering.

The bags are then placed in a drying oven for 4 days, at a temperature fixed at 40° C. under a mechanical stress applied by means of support plates placed on the bags so as to apply a pressure on each side of the accumulator contained in the bag, this treatment making it possible to obtain corrosion of the layer composed of lithium and diffusion of lithium ions through the entire thickness of the negative electrode.

After these 4 days, the accumulator conforming with the invention and the accumulator not conforming with the invention are subjected to a formation cycle at C/10 then a cycling test at C/2 for more than 200 cycles.

The results of the formation cycle are given in the following table:

| | Charged | Discharged | Irreversibility |
|---|---|---|---|
| | capacity | capacity | ratio |
| Accumulator | (in mAh) | (in mAh) | (in %) |
| Conforming with | 46 | 41 | 11 |
| the invention | | | |
| Not conforming | 46 | 38 | 17 |
| with the invention | | | |

It is found that the accumulator conforming with the invention has a lower irreversibility ratio that the accumulator not conforming with the invention, which confirms the improvement made by the presence of through holes, particularly at the current collector.

The results of the cycling test at C/2 are represented on FIG. 4 attached in the appendix, that illustrates a graph representing the variation of the discharged capacity C (in mAh) as a function of the number N of cycles, curve a) illustrating the curve relative to the accumulator conforming with the invention and curve b) illustrating the curve for the accumulator not conforming with the invention.

It is found that the accumulator conforming with the invention has better cyclability, which also certifies that diffusion of lithium derived from corrosion of the layer composed of lithium is homogeneous throughout the entire thickness of the negative electrode.

1. Negative electrode for an accumulator functioning based on the ion insertion and deinsertion principle and/or based on the alloy formation and dealloying principle, said negative electrode comprising:
a first layer (3) comprising an active material deposited via one of its faces, on a first face of a current collector (5);
a second layer (7) comprising an active material deposited via one of its faces, on a second face of a current collector (5), said first face being opposite said second face;
wherein the current collector (5) is provided with through holes (6) connecting the first layer to the second layer and in that the first layer is coated with a layer composed of a metal (1), the corresponding cations of which are those used in the ion insertion and deinsertion process and/or in the alloy formation and dealloying process in the active material of the first layer and the second layer.

2. Negative electrode according to claim 1, wherein the active material, either for the first layer and/or the second layer, is chosen from among:
silicon;
a carbon material such as hard carbon, natural graphite or artificial graphite; and;
mixtures thereof.

3. Negative electrode according to claim 1, wherein the active material, either for the first layer and/or the second layer, is tin.

4. Negative electrode according to claim 1, wherein the layer composed of a metal (1) is a layer composed of an alkali metal or a layer composed of an alkali-earth metal.

5. Negative electrode according to claim 1, wherein the layer composed of a metal (1) is in the form of metal foil.

6. Negative electrode according to claim 1, wherein the layer composed of a metal (1) has a thickness greater than or equal to 20 μm.

7. Negative electrode according to claim 1, wherein the current collector (5) comprises one or several metals chosen from among copper, aluminium, nickel and alloys thereof.

8. Negative electrode according to claim 1, wherein the first layer (3) is provided with through holes located along the prolongation of the holes in the current collector.

9. Negative electrode according to claim 1, wherein the second layer (7) is provided with through holes located along the prolongation of the holes in the current collector.

10. Method of preparing a negative electrode as defined in claim 1, comprising the following steps:
a) a step to deposit on a first face of a current collector in which there are through holes, a first layer comprising an active material and a second layer comprising an active material on a second face of the current collector, said first face and said second face being opposite each other;
b) a step to deposit a layer composed of a metal on the first layer comprising the active material, the corresponding cations of the layer composed of a metal are those involved in the ion insertion or deinsertion process in the active material of the first layer and the second layer or in the alloy formation and dealloying process in the active material of the first layer and the second layer.

11. Method of preparing a negative electrode as defined in claim 1, comprising the following steps:
c) a step to deposit a first layer on a current collector, comprising an active material on a first face of an unperforated current collector and a second layer comprising an active material on a second face of the current collector, said first face and said second face being opposite each other;
d) a step to apply a perforator on the assembly obtained in step a), to form the collector provided with through holes;
e) a step to deposit a layer composed of a metal on the first layer comprising the active material, the corresponding cations of the layer composed of a metal are those involved in the ion insertion and deinsertion process in the active material of the first layer and the second layer or in the alloy formation and dealloying process in the active material of the first layer and the second layer.

12. Method of activating a negative electrode as defined according to claim 1, comprising a step to bring the negative electrode into contact with an electrolyte for a fixed duration and at a fixed temperature to cause corrosion of the metal in the layer composed of a metal into metal cations.

13. Accumulator functioning based on the principle of ion insertion-deinsertion or the alloy formation and dealloying process comprising a negative electrode as defined according to claim 1.

14. Accumulator according to claim 13, that comprises a first cell and a second cell separated from each other by the current collector (27) of the negative electrode, said first cell containing a positive electrode (31), a first electrolytic separator (29) and the first layer (21) comprising an active material coated with the layer composed of a metal (23) of the negative electrode (20), the first electrolytic separator (29) being arranged sandwiched between the positive electrode (31) and the layer composed of metal (23) and said second cell comprising a positive electrode (35), a second electrolytic separator (33) and the second layer (25) comprising an active material of the negative electrode (20), said second electrolytic separator (33) being arranged sandwiched between the positive electrode (31) and the second layer (25) comprising an active material.

15. Accumulator functioning based on the principle of ion insertion-deinsertion or the alloy formation and dealloying process comprising a negative electrode obtained after the activation method defined in claim 12.

16. Accumulator according to claim 15, that comprises a first cell and a second cell separated from each other by the current collector (27) of the negative electrode, said first cell containing a positive electrode (31), a first electrolytic separator (29) and the first layer (21) comprising an active material coated with the layer composed of a metal (23) of the negative electrode (20), the first electrolytic separator (29) being arranged sandwiched between the positive electrode (31) and the layer composed of metal (23) and said second cell comprising a positive electrode (35), a second electrolytic separator (33) and the second layer (25) comprising an active material of the negative electrode (20), said second electrolytic separator (33) being arranged sandwiched between the positive electrode (31) and the second layer (25) comprising an active material.
